(19) United States
(12) Patent Application Publication
(10) Pub. No.: US 2006/0080132 A1
(43) Pub. Date: Apr. 13, 2006

(54) Method for generating, accessing, and managing property inspection reports

(76) Inventors: Greg S. Hall, Roswell, GA (US); Richard C. Trezza, Bernardsville, NJ (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/249,752

(22) Filed: Oct. 13, 2005

Related U.S. Application Data
(60) Provisional application No. 60/618,557, filed on Oct. 13, 2004.

(51) Int. Cl. G06Q 99/00

(52) U.S. Cl. 705/1

(57) ABSTRACT

The present invention provides a system and method for use by a property inspection company to receive requests for property inspections from customers, dispatch the requests to inspectors, receive inspection reports prepared by the inspectors, and store the reports in a database for retrieval by customers via a computer network. In addition, the present invention provides a system and method for automatically dispatching the requests to a preferred inspector using information associated with the requests and information associated with the company's inspectors. Further, the present invention provides a system and method for mining the database to generate management reports from the property inspection reports, which may be used to determine loss trends and predictors.

### RELATED APPLICATION

This application claims the benefit of priority of U.S. provisional application Ser. No. 60/618,557, filed Oct. 13, 2004, which is relied on and incorporated herein by reference.

### FIELD OF THE INVENTION

The present invention relates to a system and method used by a property inspection company for receiving orders from customers for property inspection reports, creating property inspection reports, and transmitting the resulting property inspection reports to the customers. In addition, the present invention creates a database for the customers from which management reports can be generated from the property inspection reports.

### BACKGROUND OF THE INVENTION

Historically, customers, including insurance companies, insurance underwriters, banks, real estate agents, real estate developers, or the like, have received property inspection reports from property inspection companies via paper media. Recently, some property inspection companies have begun allowing their customers to order property inspections online with delivery of the property inspection report in a PDF format. Such systems and methods do not offer an integrated system and method for ordering, creating, and transmitting property inspection reports to customers. Further, such prior systems and methods do not create a useful database for customers from which management reports can be generated and, in the case of insurance companies, risk assessment can be readily ascertained from the property inspection reports.

### SUMMARY OF THE INVENTION

The present invention overcomes the problems above by providing a system and method for use by a property inspection company to receive requests for property inspections from customers, dispatch the requests to inspectors, receive inspection reports prepared by the inspectors, and store the reports in a database for retrieval by customers via a computer network. In addition, the present invention provides a system and method for automatically dispatching the requests to a preferred inspector using information associated with the requests and information associated with the company's inspectors. Further, the present invention provides a system and method for mining the database to generate management reports from the property inspection reports, which may be used to determine loss trends and predictors.

In accordance with the present invention, an integrated property inspection method is provided in which property condition, including loss control information, is captured field by field in a database environment. This provides multiple benefits:

Ease and quickness of ordering.

Immediate transfer of inspection assignments to field representatives (inspectors) through automatic dispatch.

Paperless archiving inspection reports with search capability.

Field representative ease of use.

Management reports.

Data mining capabilities for a variety of customers.

In accordance with the present invention, inspection orders from customers can be accepted by the property inspection company via four methods of information transfer. The first method constitutes manual entry into ordering screens on web enabled software maintained by the property inspection company. The second method constitutes bulk ordering via uploading Microsoft Excel spreadsheets in CSV file format. The third method constitutes an upload of an XML file which is generated by the customer's system and requires limited programming on the inspection company side. The final method is a true XML transfer. A true XML transfer initiates from a customer's software, such as an insurance company's policy issuance software, and is directed to the inspection company's system. The true XML transfer process allows for the least amount of human error and is the quickest method of ordering. The XML transfer process as a whole takes seconds to complete and no additional manual human intervention is required to initiate this XML transfer process.

When an order for an inspection report is first placed, the inspection company's system searches for a field representative (inspector) designated for automatic dispatch. If no field representative susceptible of automatic dispatch is found, then the inspection company's system defaults to manual dispatching. If field representatives eligible for automatic dispatch are found, the inspection company's system will then perform a search to determine the best available field representative. Particularly, the inspection company's system searches among the eligible field representatives based upon their dispatch radius, number of orders in the field representatives' possession, and their proximity to the zip code of the property that is the subject of the inspection order.

When the inspection order is dispatched, the inspection company's system automatically generates an email of the order to the selected field representative with all pertinent information required for completing the property inspection. Thus the inspection order is in the field representative's possession within minutes of receipt of the inspection order from the customer.

The inspection company's software not only benefits the customer in terms of speed of dispatch, but the field representatives are benefited as well. Because the inspection company's system is web enabled, the system allows field representatives to complete the property inspection reports on the web through the use of laptop computers or Internet enabled PDAs. This ability creates increased efficiencies for the field representatives.

Regardless of the customer's customized inspection report layout (template), which is merely a reflection of the database content, the field representatives enter the data in the same way and order for each customer. When the information is entered by the field representative into the inspection report, the database validates the data for content and logic. This allows field representatives to know immediately if they have entered incorrect information or omitted required information. This process greatly minimizes clerical and technical errors thereby providing a higher level of quality while decreasing turn around times to customers.

Once the inspection reports are completed by the field representatives, they are archived on the inspection company's secure server which allows the inspection reports to be accessed at anytime from anywhere with nothing more than an Internet browser. Further, because the ordering information is stored in the database, property inspection reports can be retrieved using a detailed search engine. This means even without full information, inspection reports can be found. For example, if an insurance company does not know the policy number or insured name but merely a portion of an address, the inspection report can be located in the database. In addition to printing and saving a paper copy of the property inspection report, customers can also transfer the inspection reports to their own systems. This transfer can be completed by saving the files or merely saving a link to the files on the inspection company's server. By utilizing the links the customers take up very little of their own hard drive space.

One of the most important aspects of capturing the detailed data elements from the inspection reports in a database environment is the ability to query the database and run management reports for the customers. The ability to run these management reports allows customers, such as in the case of an insurance company, to efficiently identify problem areas within their risk portfolios. The ability to generate management reports also allows customers to aggregate information to better understand their books of business. For example, if an insurance company intends to stop writing insurance for frame dwellings, a management report can be generated that identifies frame construction within the inspection reports completed for that insurance company. These management reports can be generated periodically by the inspection company's computer systems analyst or programmed for the customer to run the report at will. These management reports can be customized to query thousands of property inspection data elements, thus allowing the inspection company to build reports specific to the needs of the individual customers that it services.

In addition, management reports increase efficiency for the customers. For example, the inspection company may complete two hundred inspections in any given period, yet by utilizing the management reports there may be only five property inspection reports that have negative implications for the customer. In addition, when viewing the management reports on the inspection company's web based system, an order number is shown which hyperlinks directly to the report in question. These items can then be prioritized and handled expeditiously by the customer.

The capture of substantial amounts of inspection data in a database environment creates the option of performing data mining activities. This can include simply aggregating data to better understand one's portfolio or, more importantly, merging property inspection data elements with other useful information. Such information might include underwriting data, claims data, and/or non-industry information. The ability to merge this information will allow customers, such as insurance companies, to underwrite risk portfolios utilizing literally hundreds of fields of information. Data mining the information in the inspection company's database will allow the insurance companies with access to the database to analyze their books of business in order to find loss trends and loss predictors that otherwise might never be found.

Further objects, features and advantages will become apparent upon consideration of the following detailed description of the invention when taken in conjunction with the drawings and the appended claims.

### BRIEF DESCRIPTION OF THE DRAWINGS

FIG. 1 is a schematic diagram of the database tables for the system used in implementing the method of the present invention.

FIG. 2 is a flow diagram of the principal steps of the method of the present invention.

FIG. 3 is a flow diagram of the customer addition process in an embodiment of the present invention.

FIG. 4 is a flow diagram of the program addition process in an embodiment of the present invention.

FIG. 5 is a flow diagram of the template addition process in an embodiment of the present invention.

FIG. 6 is a flow diagram of the insurance carrier addition process in an embodiment of the present invention.

FIG. 7 is a flow diagram of the user addition process in an embodiment of the present invention.

FIG. 8 is a flow diagram of the administrator ordering process in an embodiment of the present invention.

FIG. 9 is a flow diagram of the customer ordering process in an embodiment of the present invention.

FIG. 10 is a flow diagram of the field representative dispatching process in an embodiment of the present invention.

FIG. 11 is a flow diagram of the field representative's pre-inspection process in an embodiment of the present invention.

FIG. 12 is a flow diagram of the post-inspection report completion process in an embodiment of the present invention.

FIG. 13 is a flow diagram of the inspection report review process in an embodiment of the present invention.

FIG. 14 is a flow diagram of the order holding process in an embodiment of the present invention.

FIG. 15 is a flow diagram of the designated customer for hourly billing process in an embodiment of the present invention.

FIG. 16 is a flow diagram of the order re-dispatch and un-dispatch process in an embodiment of the present invention.

FIG. 17 is a flow diagram of the order cancel and delete process in an embodiment of the present invention.

FIG. 18 is a flow diagram of the expense designation process in an embodiment of the present invention.

FIG. 19 is a flow diagram of the client billing and expense reporting process in an embodiment of the present invention.

FIG. 20 is a flow diagram of the invoice uploading process in an embodiment of the present invention.

FIG. 21 is a flow diagram of the invoicing process in an embodiment of the present invention.

FIG. 22 is a flow diagram of the process for creating a billing spreadsheet in an embodiment of the present invention.

FIG. 23 is a flow diagram of the process for generating a management report in an embodiment of the present invention.

FIG. 24 is a flow diagram of the process for accessing a management report in an embodiment of the present invention.

### DETAILED DESCRIPTION OF THE INVENTION

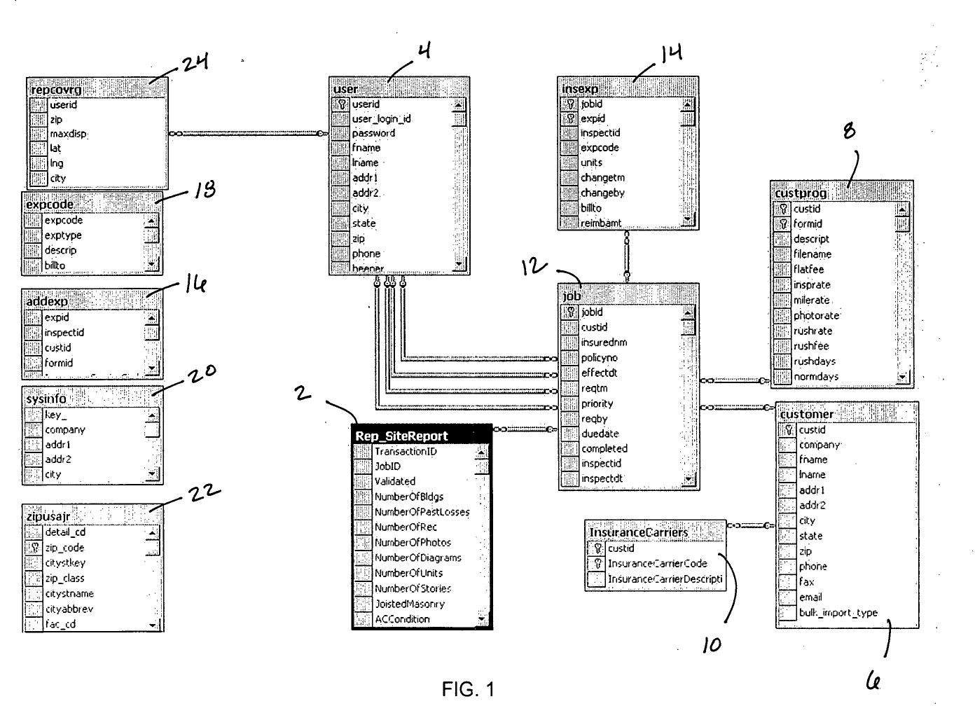

Referring now to the drawings, in which like reference numerals represent like parts throughout the several views, FIG. 1 shows the database tables used in connection with implementing the method of the present invention. Below is a description of each of the database tables shown in FIG. 1.

### Database Table Descriptions

Rep_SiteReport: A Rep_SiteReport table 2 contains all information relating to online inspection reports.

User: A User table 4 contains all user information. Users include inspection company administrators, customers, and field representatives (inspectors).

Customer: A Customer table 6 contains all customer information.

Custprog: A Custprog table 8 contains all customer programs information, such as property insurance, liability insurance, etc.

InsuranceCarriers: An InsuranceCarriers table 10 contains information relating to insurance carriers.

Job: A Job table 12 contains all information relating to inspection orders. The Job table 12 serves as a hub to link all other tables.

Insexp: An Insexp table 14 contains all inspection expenses information. The Insexp table 14 is used to generate invoices.

Addexp: An Addexp table 16 contains all additional expenses information. The Addexp table 16 is also used for invoicing.

Expcode: An Expcode table 18 contains a set of expense codes, which are used to identify expense types.

Sysinfo: A Sysinfo table 20 contains information about the particular inspection company providing the inspection services.

Zipusajr: A Zipusajr table 22 contains all U.S. zip code information. The Zipusajr table 22 is used to automatically dispatch an inspection order to one of the nearest field representatives.

Repcovrg: A Repcovrg table 24 contains information relating to a field representative's inspection range.

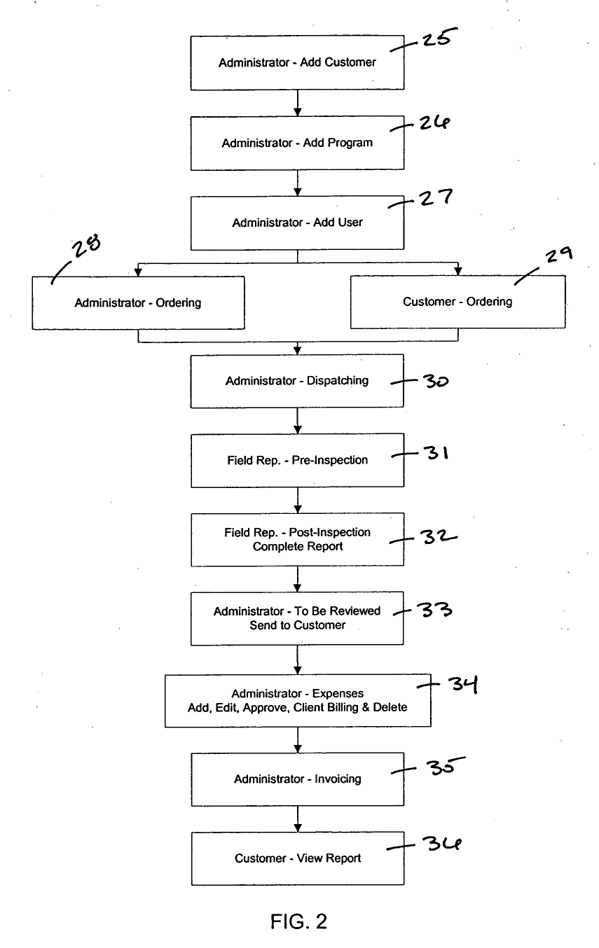

With reference to FIG. 2, FIG. 2 shows the principal steps 25-36 in a property inspection method in accordance with the present invention. Additional, supplemental steps may also be incorporated into the property inspection method. The individual steps shown in FIG. 2 and the supplemental steps are described in further detail below.

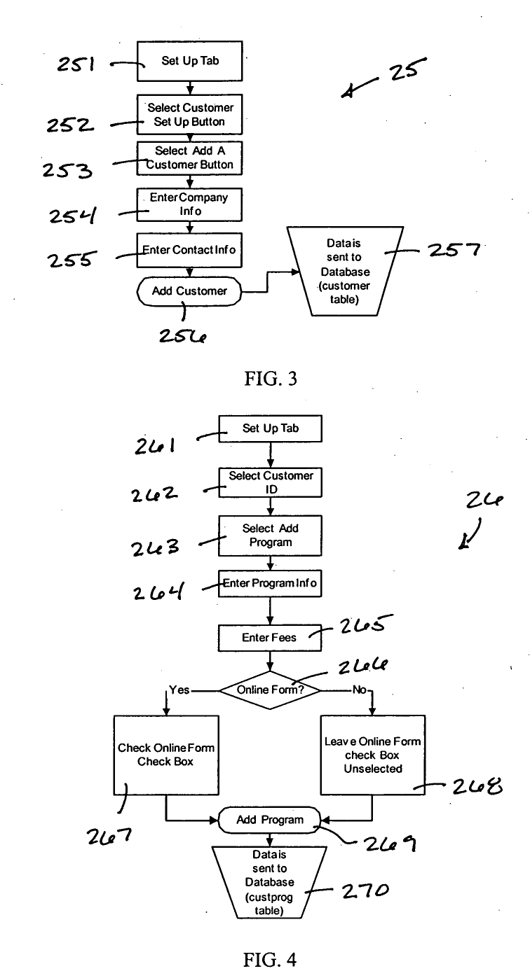

With reference to FIG. 3, in step 25 (FIG. 2) of the method of the present invention, a customer (e.g., an insurance company) is added to the inspection company's database at steps 251-257. All general contact information is entered, and a customer identification is chosen. Once the customer has been added to the inspection company's database, programs, templates, and insurance carrier specific information is added for the particular customer.

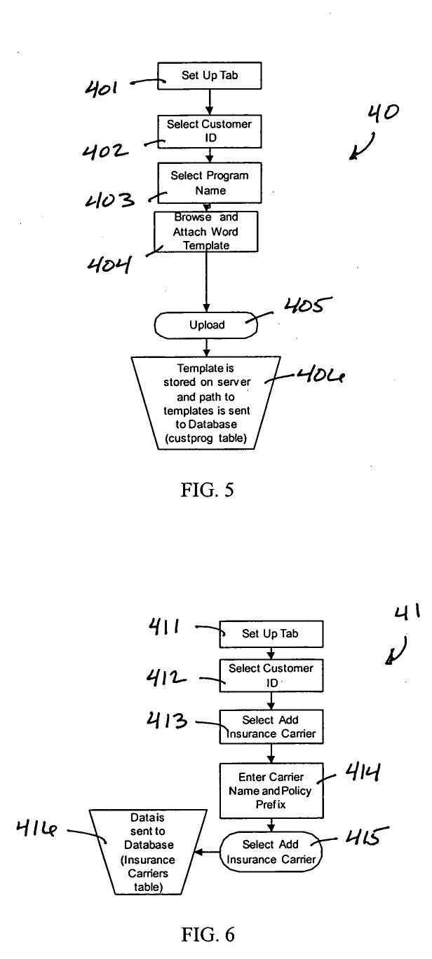

With reference to FIG. 4, in step 26 (FIG. 2) a program is associated with the customer at steps 261-270. Particularly, a program consists of a group of similar insurance policies such as property insurance policies, liability insurance policies, etc. A program is associated with the customer by entering the program name, billing information, turnaround time requested, and other pertinent information about the services to be rendered to the customer for that particular program. At step 266, it is determined whether the customer is eligible for an online format. If not, the online form is left unchecked at step 268, and a text template will be uploaded to the system at supplemental step 40, shown in FIG. 5.

With reference to FIG. 6, in supplemental step 41, the inspection company may add an insurance carrier for the customer to the customer database. The system is configured to create multiple invoices for customers with more than one insurance carrier for a particular customer program. The system determines to which invoice the orders belong based upon a policy number prefix given for the insurance carrier. This is beneficial because an insurance company may need to submit separate invoices to separate insurance carriers for repayment. Consequently, invoicing is simpler if the invoices are separated in advance. Alternatively, the invoices may be handled by different members of the insurance company. Separation of invoices in both scenarios will help expedite payment.

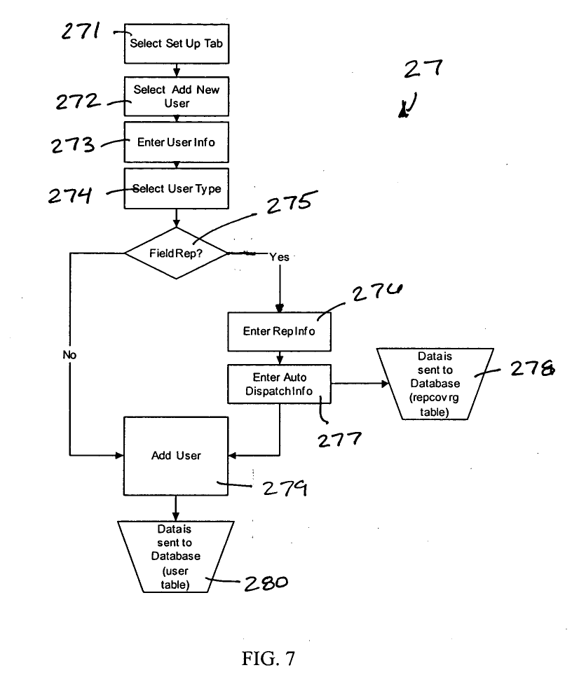

Turning to FIG. 7, in step 27 (FIG. 2) a user is added to the inspection company's database at steps 271-280. The method of the present invention contemplates four types of users, and each user has predefined rules for viewing information and inspection order status. The four types of users are administrator and assistant administrator, both associated with the inspection company, customer, and field representative. For example, only an administrator has access to billing information. A customer can only view reports that correspond to its assigned customer identification. In order to establish access limits for field representatives and to establish availability for automatic dispatching (described below), a field representative must enter its representative information and its automatic dispatching information at steps 276 and 277. For each field representative, automatic dispatch information is entered at step 277 if automatic dispatching is desired. In one embodiment, the automatic dispatch information includes a dispatch radius and a maximum number of orders allowed. Accordingly, the automatic dispatch information represents the field representative's area and radius of coverage and the volume of work allocated to that representative during any period of time.

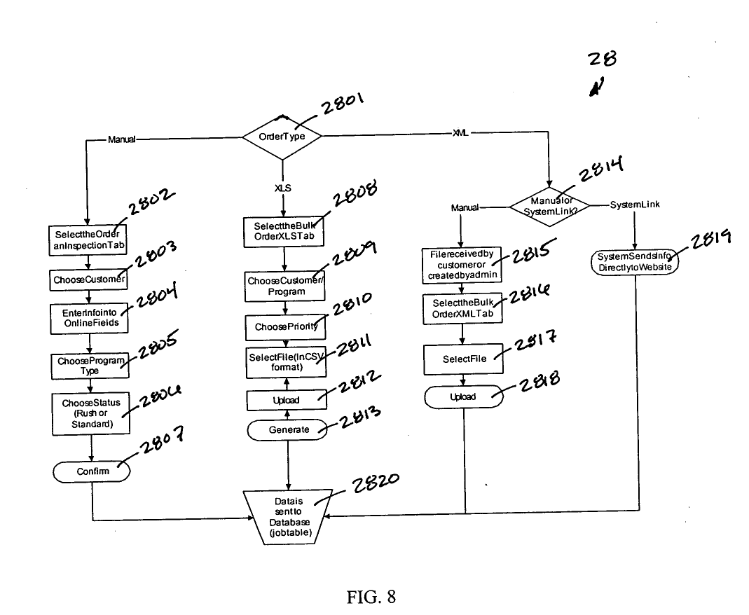

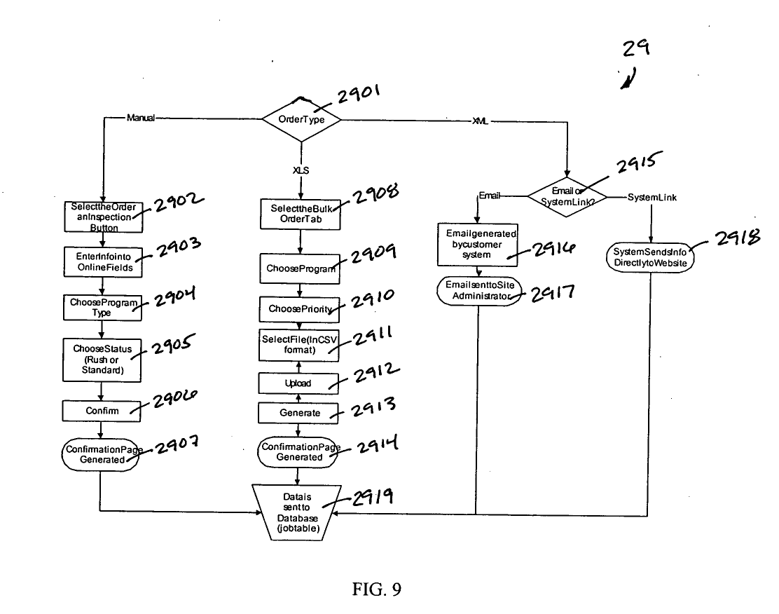

Turning to FIGS. 8 (administrator ordering, step 28 (FIG. 2)) and 9 (customer ordering, step 29 (FIG. 2)), ordering an inspection can be accomplished in several ways including manual online entry (FIG. 8, steps 2802-2807; FIG. 9, steps 2902-2907), bulk order XLS file uploading (FIG. 8, steps 2808-2813; FIG. 9, steps 2908-2914), or XML file transfer (FIG. 8, steps 2814-2819; FIG. 9, steps 2915-2918). Bulk ordering is done by uploading an Excel, CSV file in a predetermined format from the customer to the inspection company system. The bulk ordering XLS file upload allows for a one file upload of multiple insureds and locations for the same program type with no additional programming needed. The XML file transfer allows the customer's system, with the touch of a button, to send orders to the inspection company's system. The uploaded XML files contain the inspection order information which has already been keyed into customer's system. While the XML file transfer method requires some programming at the inspection company server, the XML file transfer method decreases the likelihood of human error involved in the ordering process. If the customer does not wish to link its systems for XML transfer, the customer can still email XML files for uploading into the inspection company's system.

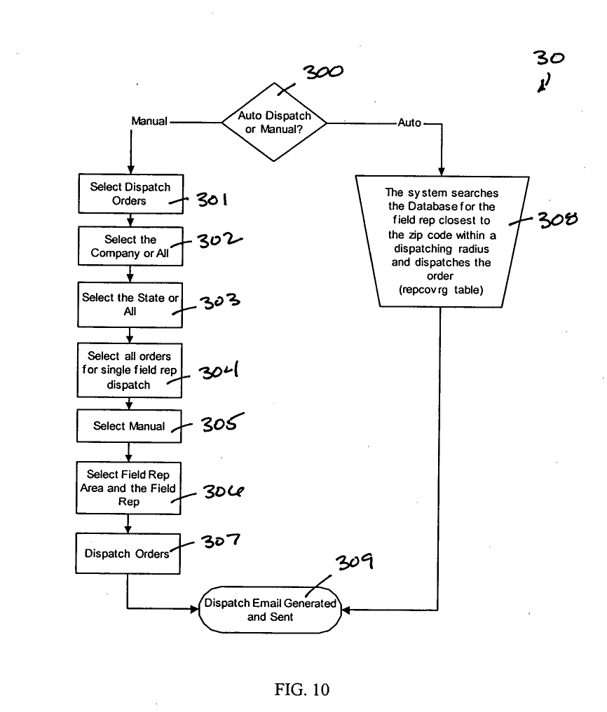

With reference to FIG. 10, in step 30 (FIG. 2) dispatching of inspection orders to field representatives is done in one of two ways: manually at steps 301-307 or automatically at step 308. When an order is first placed, at step 300 the inspection company's system searches for field representatives that were designated for automatic dispatch at step 27 (FIG. 27). If a field representative designated for automatic dispatch is not found, then the system defaults to manual dispatching and proceeds to step 301. Manual dispatching may be performed by the administrator either one at a time or in bulk. All field representatives are eligible for manual dispatch and all predefined criteria entered at step 27 can be overridden.

If field representatives are found that are eligible for automatic dispatch, the system then performs a search at step 308 to identify a preferred field representative. The system searches among the eligible field representatives and identifies the preferred field representative using the automatic dispatch information of each eligible field representative. In the described embodiment, for each eligible field representative, the system determines whether the zip code associated with the order is within the representative's dispatch radius and the distance between the field representative and the location associated with the order. The system also determines the number of orders currently in the representative's possession and compares such number to the maximum number of orders allowed for that representative. The preferred field representative for the order is identified as the eligible field representative whose dispatch radius includes the zip code associated with the order and who has less orders in their possession that the maximum number of orders allowed. If more than one field representative meets the aforementioned criteria, the preferred field representative is identified as the field representative meeting such criteria that is closest to the location associated with the order.

Table 1 and the example below show how one of the field representatives, A, B, C, and D, may be identified as the preferred field representative.

TABLE 1
Automatic Dispatch Example.

| Criteria | A | B | C | D |
|---|---|---|---|---|
| Eligible for automatic dispatch? | Yes | Yes | Yes | Yes |
| Zip code within radius? | Yes | Yes | Yes | No |
| Distance to location (in miles)? | 5 | 10 | 7 | 40 |
| Maximum number of orders allowed? | Yes | No | No | No |

Field representative D is automatically disqualified because the zip code associated with the order is not within field representative D's dispatch radius. Field representative A is disqualified because he or she has reached the maximum number of orders allowed at any given time. Both field representative B and C are eligible, but field representative C will be identified as the preferred field representative because he or she is closer to the location associated with the order.

Accordingly, the method of the present invention is configured to automatically select the preferred field representative using certain objective and variable criteria (e.g., zip code and current number of orders), rather than requiring a user to manually and subjectively identify a preferred field representative using fixed criteria. Thus, the automatic dispatching function of the present invention manages the workload of the field representatives in an efficient and effective manner.

With continuing reference to FIG. 10, at step 309 the field representative identified, either manually or automatically, to complete the order is notified via email of the order and provided with all pertinent information required for completing the property inspection.

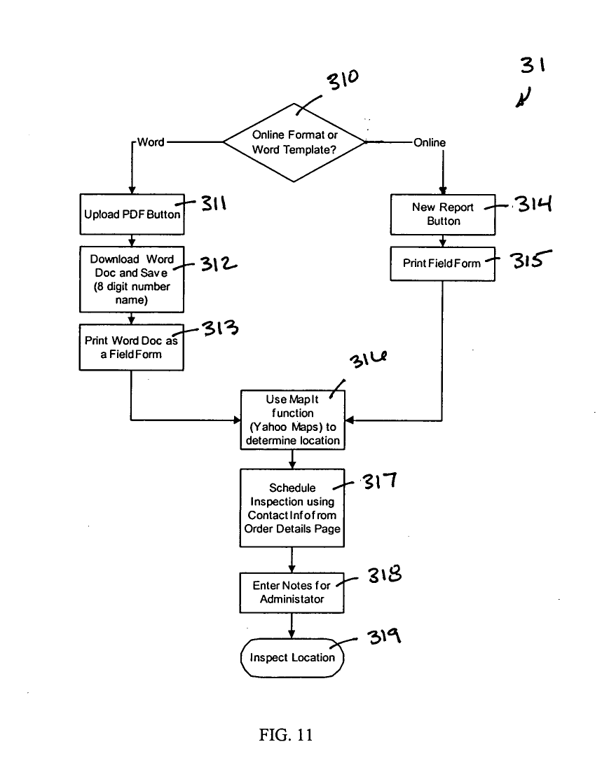

Turning to FIG. 11, in step 31 (FIG. 2) the field representative performs certain pre-inspection tasks at steps 310-318 and inspects the property at step 319. Field representatives typically bring field forms along on inspections. These forms list all questions with all possible answers and include areas to write notes. If the inspection order is a text template, the field representative can print out the template at step 313 and bring the printed form along on the inspection. If the inspection order is an online form, there are blank field forms available and attached to the inspection order for printing at step 315.

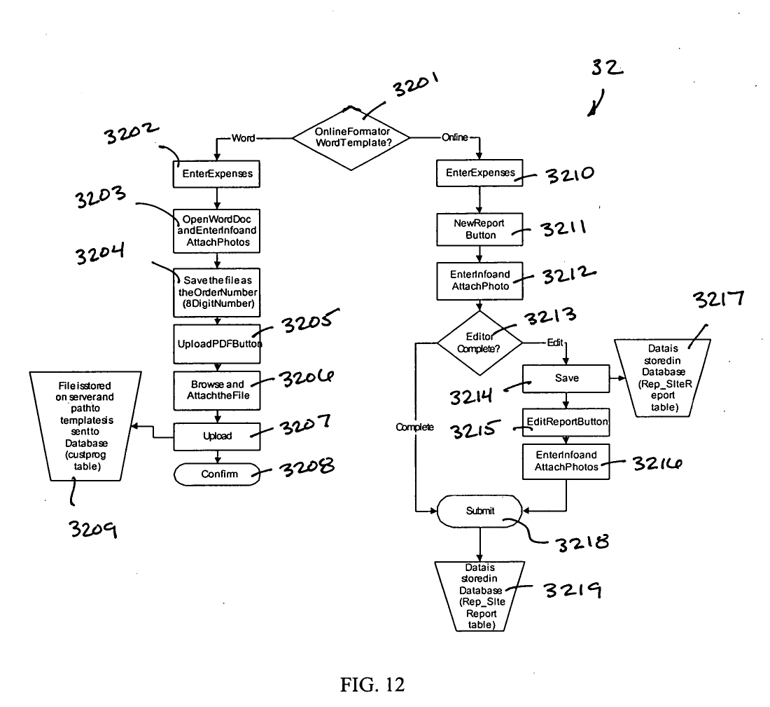

With reference to FIG. 12, in step 32 (FIG. 2) the field representative completes the inspection report at steps 3201-3219. First, the field representative enters expenses at step 3202. When completing the text templates, the information is typed into the text document and photos are pasted into the document at step 3203. In one embodiment of the present invention, the inspection report file (text and images) is then saved with the order number to which it corresponds at step 3204. In such an embodiment, the name of the file and the order number match.

When completing an online form, the field representative also enters expenses at step 3210. The inspection report file is typically a selected format (e.g., Microsoft Word) which is recognized by the system as a precondition for allowing uploading of the file and entry of expenses. Once the information has been entered into the form and the photos attached at step 3212, the form is submitted at 3218. Upon saving or submitting the form, the system is configured to validate the data for type and logic. If there is an error, the error is highlighted in red and uploading is denied. The completed forms represent the inspection reports.

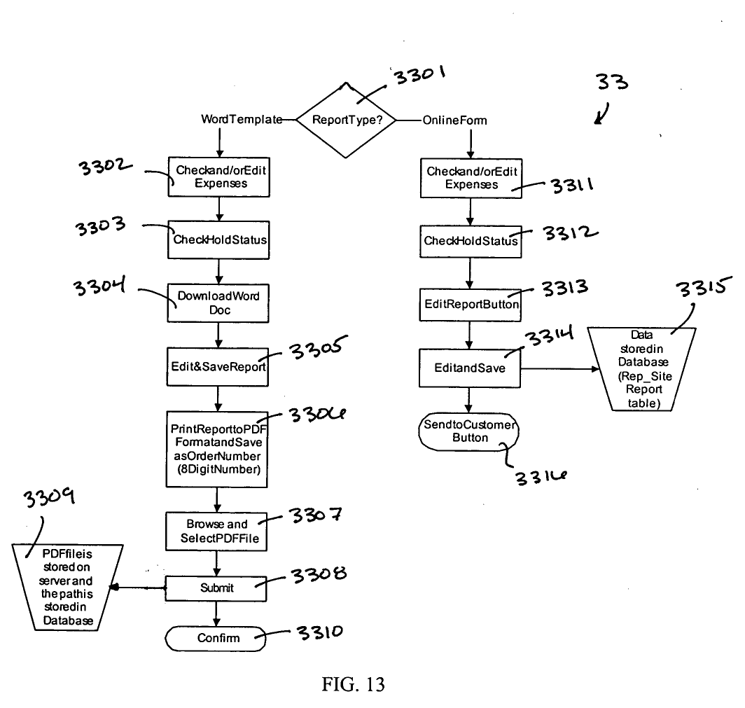

Turning to FIG. 13, in step 33 (FIG. 2), once the inspection reports are completed and submitted by the field representatives, the inspection reports are subject to review by the inspection company. At steps 3301-3316, administrators and assistant administrators can review and edit the reports, confirm billing, and send the reports to customers. One of the most notable differences between text templates and online forms is data validation. As previously described, when online reports are completed by field representatives, the system checks the data format as well as its logic. The inspection company's system also blocks a field representative from submitting an incomplete report. When completing a text document, incorrect and/or illogical data can be entered. The text template format calls for much more extensive review.

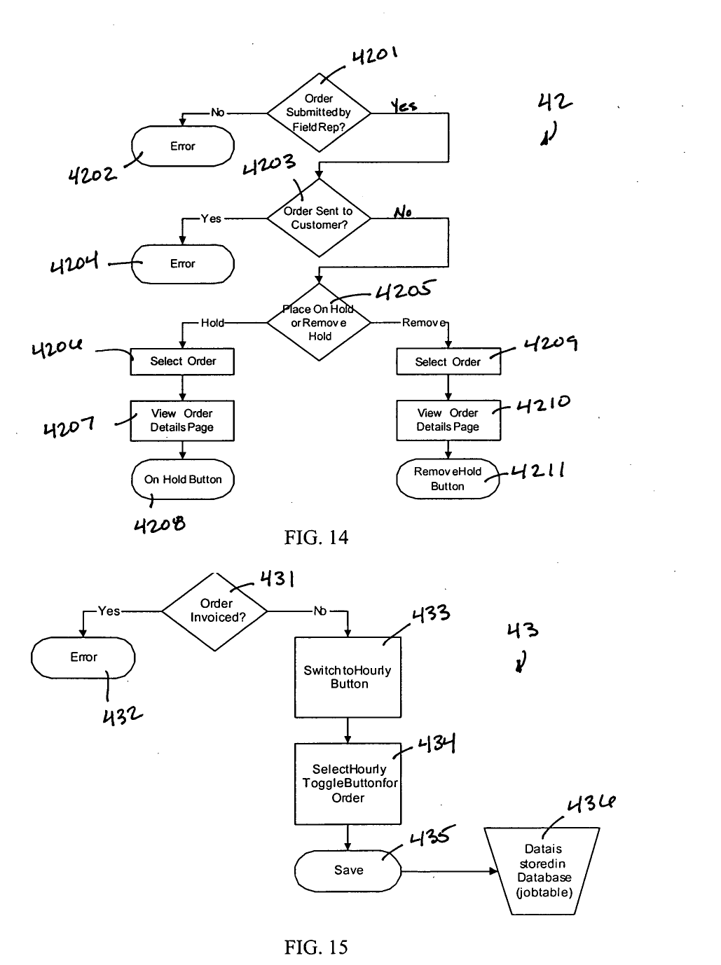

Turning to FIG. 14, in supplemental step 42 the order may be placed on hold or removed from hold at steps 4201-4211. Placing orders on hold precludes assistant administrators at the inspection company from uploading an inspection report. The only user capable of uploading the report subject to a hold order or removing the hold is an administrator. In addition, placing orders on hold acts as a flag to other administrators that the order has been reviewed. The user identification and the date are shown so other users will know who is handling the order subject to the hold.

When a customer is added to the system, the system defaults to a flat rate billing format. This is the preferred method of billing. However, there are instances which require hourly billing so the system is configured to accommodate an hourly billing format as well. With reference to FIG. 15, in supplemental step 43 the customer may be designated for hourly billing at steps 431-436.

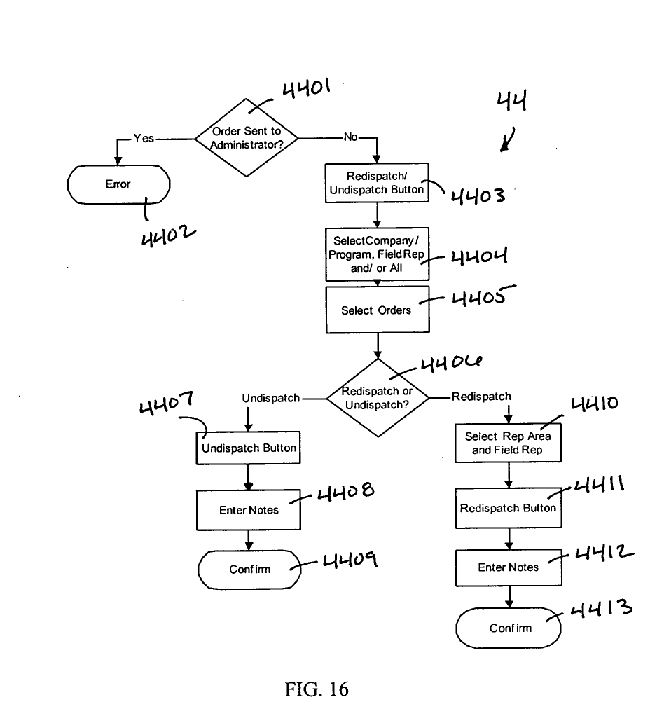

Turning to FIG. 16, in supplemental step 44 the order may be withdrawn from dispatch or re-dispatched at steps 4401-4413. Withdrawing an order from dispatch causes the order to be reposted as a new order to be dispatched manually at a later time. When an order is re-dispatched to the selected field representative, the order is treated the same as manual dispatching (FIG. 10, steps 301-307), and an email is generated and sent to the field representative (FIG. 10, step 308). The status of the order does not change as a result of re-dispatching.

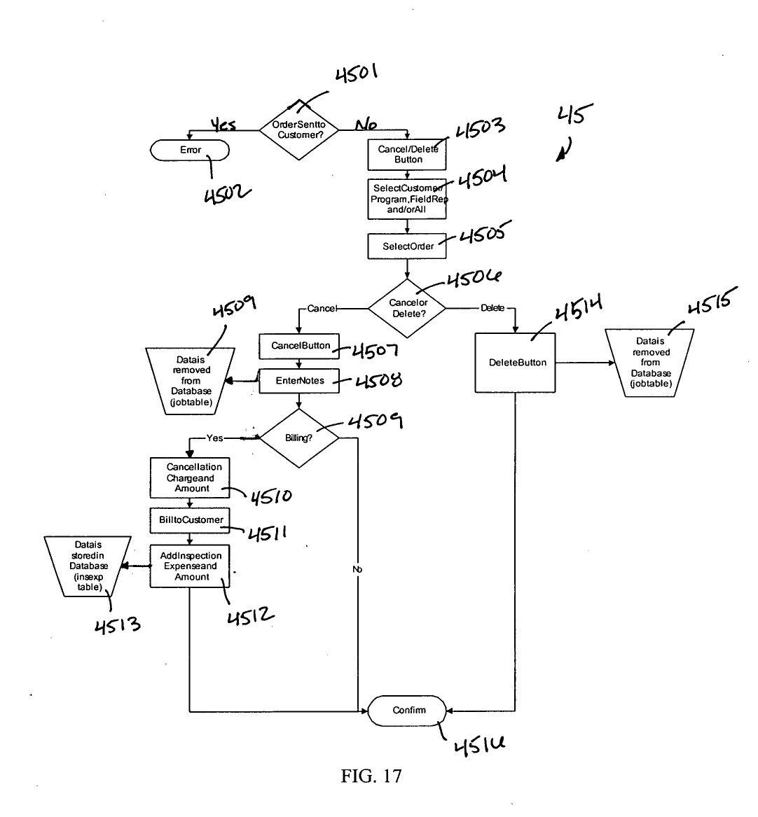

Turning to FIG. 17, in supplemental step 45 the order may be cancelled or deleted at steps 4501-4516. The major difference between canceling and deleting an inspection order is data retention. When an inspection order is deleted, only minimal information is retained. There is no billing function associated with deleting an order. When an order is cancelled, the data is retained and the order status is removed. For a canceled order, billing is limited to fees and field representative reimbursement.

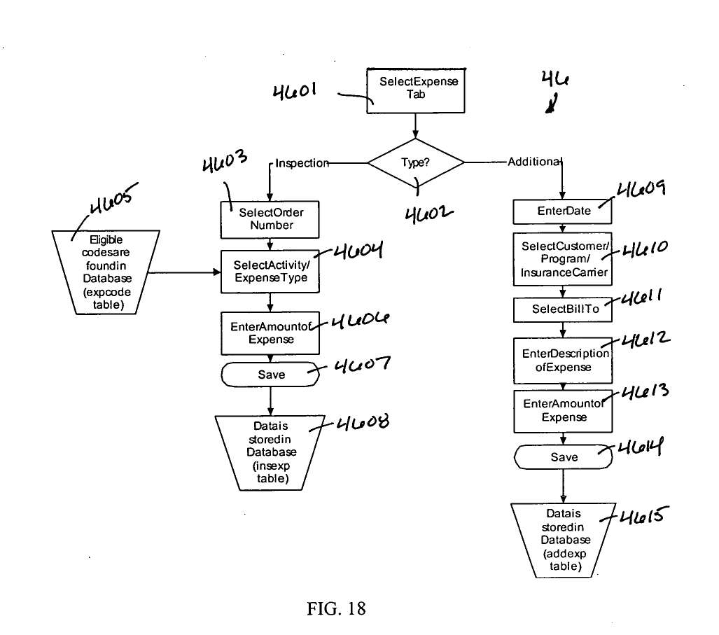

Turning to FIG. 18, in supplemental step 46 field representatives may submit an expense report at steps 4601-4615. Inspection expenses are designated for specific orders. Additional expenses are designated for a range of orders or for non-order specific expenses.

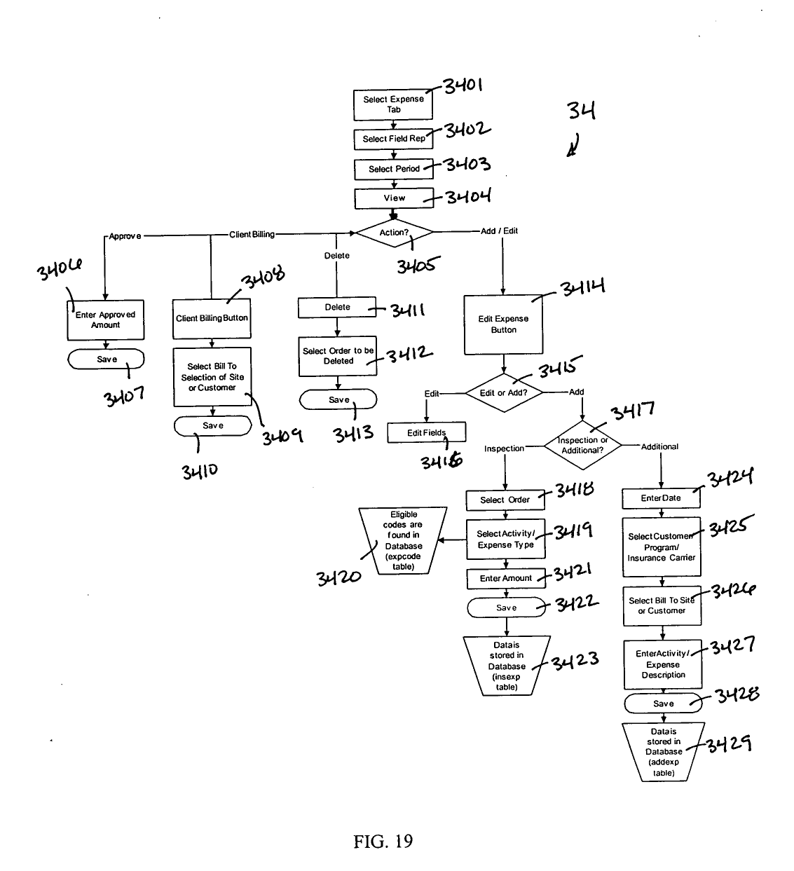

With reference to FIG. 19, in step 34 (FIG. 2) the inspection company carries out certain functions related to billing and expenses at steps 3401-3429. In one embodiment, two functions relating to expenses are provided. The first function is an expense report for field representatives, shown at steps 3418-3423. All approved expenses are reimbursed to the field representative at month end. The second function is for additional billing or reimbursement to customers, shown at steps 3424-3429. There are expenses for two inspection types. The first is inspection expenses which are designated for order specific expenses. Additional expenses are designated for a range of orders or for non-order specific expenses. For both inspection types, if the bill-to-customer option is selected, the amount specified will be reflected on the invoices.

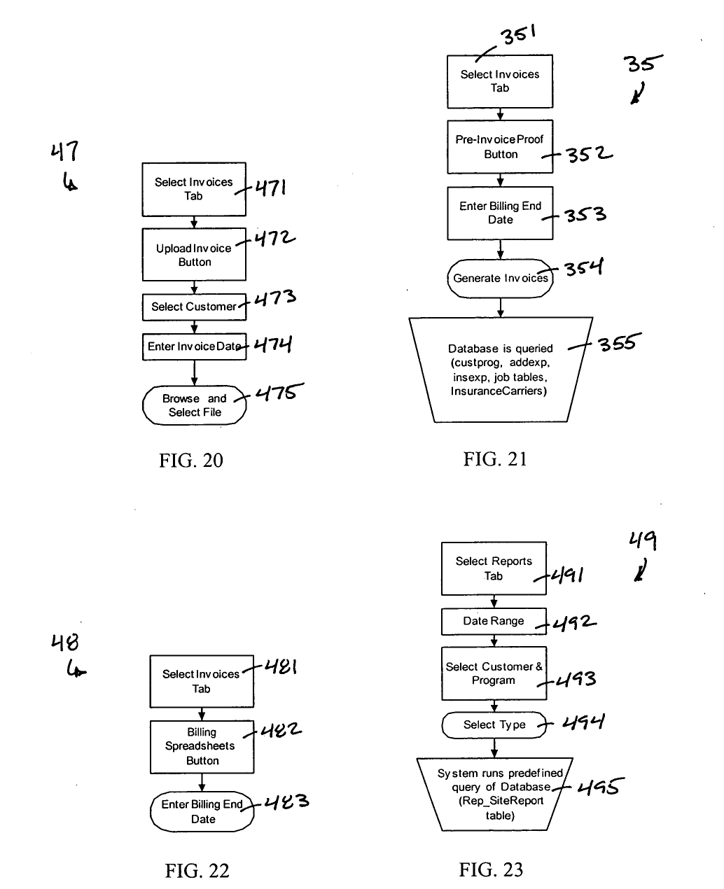

Turning to FIG. 20, in supplemental step 47 the method of the present invention allows for the uploading of an invoice to the inspection company's server for any type of billing not predefined or foreseen before billing is executed.

Turning to FIG. 21, in step 35 (FIG. 2) invoicing is generated at step 354 for orders not yet invoiced and completed on or before the billing end date entered at step 353. The amount billed for each order is determined by querying a number of tables within the database. This information is divided by customer identification, program, and insurance carriers to create separate invoices for all those criteria that apply. This information is also collected by querying the database, and the invoices are generated using a standard invoice preparation program (e.g., Crystal Reports).

Once invoicing is complete, all of the billing information is sent to a temporary folder on the inspection company's server. From this folder the system may generate, spreadsheets for each customer and program type as part of supplemental step 48, and as shown in FIG. 22. These files are used for accounting purposes and are stored on the inspection company's server.

Turning to FIG. 23, in supplemental step 49 management reports are offered to those customers who are in the inspection company's database. At step 495, the system runs a predefined query of the database (FIG. 1). The information is then viewed on the inspection company's website in a predetermined format. Management reports can be generated from a standard set of reports for the database, or management reports can be programmed for each individual customer. Also, each management report can be sorted by column headers and negative answers may be shown in red. Each management report references the order number which is a live link that directs the user to that specific order for review. If necessary, the customer can copy and paste the information into any program it chooses (e.g., Excel) for manipulation. Or, if a more extensive management report is required, the inspection company's computer analyst can query the data. The data can then be placed in a designated program type, such as Excel.

Accordingly, the present invention allows for any number of data mining activities. For example, customers can use this data for determining loss trends or predictors by merging loss and underwriting information. More specifically, the data obtained from the inspection reports and stored within the database may be compared with claims history information and analyzed using various predictive modeling, pattern discovery, outlier detection, and data mining techniques to identify patterns and anomalies that are indicative of a high risk for loss. It will be appreciated that as more data is obtained from inspection reports and added to the system, the identified patterns may be refined and a continuing learning process may be provided.

As a result of the data analysis, or pursuant to guidelines provided by the insurance carrier, the present invention may be used to monitor for high risk data patterns or specific factors and, if such a data pattern or specific factor is detected in an inspection report submitted to the system, the system may notify the carrier, such as via email, and include all pertinent information relating to the inspection report. For example, the data analysis may indicate that structures having a flat roof as opposed to a pitched roof have an elevated probability for loss. Or, a given insurance carrier may have established a guideline that it will not underwrite a structure having a flat roof as opposed to a pitched roof. In such a situation, the present invention may be configured to monitor the inspection reports uploaded to the system for structures having a flat roof and notify the carrier, such as via email, when an inspection report associated with the carrier indicates a structure having a flat roof.

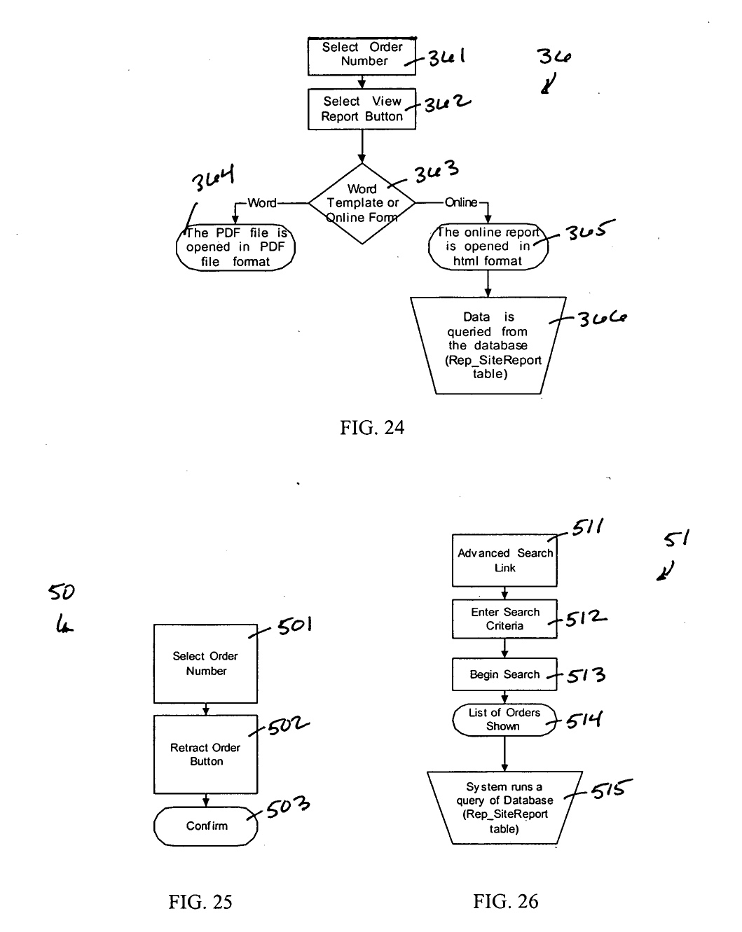

Turning to FIG. 24, in step 36 (FIG. 2) the inspection company's inspection reports can be viewed from any computer that has suitable document distribution software, such as Adobe Acrobat Reader, or an Internet browser. In the described embodiment, the PDF files are opened in PDF format at step 364, and the online forms are opened in html format at step 365. The online forms call the data directly from the database and are viewed in the programmed format. The PDF and online formats allow customers to download the files for printing individual inspection reports or storing them as an electronic link to each customer's underwriting file. An electronic link to each inspection report may be copied to email messages to allow viewing of individual inspection reports by any person without allowing access to the entire system.

Turning to FIG. 25, if for some reason there is an error on an inspection report that is sent to the customer, the order can be retracted in supplemental step 50. Retracting an order changes the status of the order and subjects the inspection report to further review. The process for uploading the inspection report is then followed. If the order is an online format, then the data is updated in the database. This process ensures that the most accurate data is stored within the database.

After an inspection report is sent to the customer and a reasonable amount of time has elapsed, such as fourteen (14) days, the order is sent to archive. Essentially this means that the order is no longer viewed on the completed orders page. Turning to FIG. 26, in supplemental step 51 in order to view or find the archived order, a search must be completed at steps 511-515. A search allows an order to be found using any of the information entered while ordering. Each individual customer can view only orders completed for their customer identification while administrators can view all orders. In addition, customers have less options for searching because customers are not privy to some information that an administrator has.

While this invention has been described with reference to preferred embodiments thereof, it is to be understood that variations and modifications can be affected within the spirit and scope of the invention as described herein and as described in the appended claims.

I claim:

1. A method for generating, accessing, and managing property inspection reports on a wide area network comprising the steps of:
a. receiving a request for at least one property inspection from a customer via the wide area network;
b. dispatching the request to an inspector via the wide area network;
c. receiving an inspection report prepared by the inspector via the wide area network, wherein the inspection report includes formatted data; and
d. storing the formatted data in a database for retrieval by the customer via the wide area network.

2. The method of claim 1, wherein the request comprises a file designating a plurality of inspection locations.

3. The method of claim 2, wherein the file is a formatted text file or an extensible markup language file.

4. The method of claim 1, wherein the dispatching the request to an inspector includes automatically searching for and identifying a preferred inspector using information associated with the request and information associated with at least one eligible inspector.

5. The method of claim 4, wherein the automatically searching for and identifying a preferred inspector includes:
a. for each eligible inspector, determining whether a location associated with the request is within a dispatch radius associated with the eligible inspector;
b. for each eligible inspector, determining a number of requests in the eligible inspector's possession and comparing the number of requests to a maximum number of requests;
c. for each eligible inspector, determining a distance between the location associated with the request and a location associated with the preferred inspector; and
d. identifying the eligible inspector having the location associated with the request within the dispatch radius associated with the eligible inspector, having the number of requests in the eligible inspector's possession that is less than the maximum number of requests, and having the shortest distance between the location associated with the request and the location associated with the eligible inspector as the preferred inspector.

6. The method of claim 5, wherein the dispatching the request to an inspector includes automatically sending information associated with the request to the preferred inspector for preparing the inspection report.

7. The method of claim 1, further comprising the step of mining the formatted inspection data to generate management information relating to users.

8. The method of claim 7, wherein the management information is indicative of loss patterns relating to risk assessment by an insurer and further comprising the step of transmitting the management information to the insurer.

9. The method of claim 7, wherein the management information is indicative of inspector performance and further comprising the step of rating inspectors based on the management information.
